(19) United States
(12) Patent Application Publication
(10) Pub. No.: US 2021/0144427 A1
(43) Pub. Date: May 13, 2021

(54) PRESENTING SERVICE OFFERINGS ON A CONSUMER DEVICE

(71) Applicant: Sony Corporation, Tokyo (JP)

(72) Inventor: Thomas Dawson, Escondido, CA (US)

(73) Assignee: Sony Corporation, Tokyo (JP)

(21) Appl. No.: 16/683,187

(22) Filed: Nov. 13, 2019

(51) Int. Cl. H04N 21/262; H04N 21/81; H04N 21/482; H04N 21/431; H04N 21/442

(52) U.S. Cl. CPC H04N 21/26241; H04N 21/812; H04N 21/4826; H04N 21/4316; H04N 21/44222; H04N 21/4821

(57) ABSTRACT

Implementations generally relate to service offerings presented on a consumer device. In some implementations, a method includes displaying a plurality of media items on a television, wherein each media item of the plurality of media items is an available service offering that a user may select. The method further includes determining a predetermined presentation policy for updating one or more media items of the plurality of media items. The method further includes updating the one or more media items based on the predetermined presentation policy.

### BACKGROUND

Manufacturers of Internet connected devices such as TVs and Blu-ray™ players typically have little or no revenue from offering third-party movie services and/or other third-party service offerings such as games, music, news, etc. As such, there is little or no funding to support the infrastructure needed for presenting lists of service offerings available. This leads to nearly static cases where the appearance of the list of service offerings looks the same anytime the customer brings it up. When service offerings do not change, they “go stale,” people lose interest, and service offerings become ignored after a period of time. To maintain the user's interest, the appearance of the items may change on a regular basis. For example, a conventional solution is to have the selection items hosted on a web page on a server, where the appearance of the selection items may be updated at any time. However, infrastructure costs are high during prime time viewing, where many devices, perhaps millions, request updates from the server at the same time. To keep infrastructure costs low, some conventional solutions update offerings only occasionally, if at all.

### SUMMARY

Implementations generally relate to television application (app) or service offerings presented on a consumer device. In some implementations, a system includes one or more processors, and includes logic encoded in one or more non-transitory computer-readable storage media for execution by the one or more processors. When executed, the logic is operable to cause the one or more processors to perform operations including displaying a plurality of media items on a television, where each media item of the plurality of media items is an available service offering that a user may select; determining a predetermined presentation policy for updating one or more media items of the plurality of media items; and updating the one or more media items based on the predetermined presentation policy.

With further regard to the system, in some implementations, one or more presentation policies involve at least a predetermined time schedule. In some implementations, one or more presentation policies involve at least a predetermined ordering. In some implementations, one or more presentation policies are based at least on a state of the television. In some implementations, one or more presentation policies are based at least on a contractual agreement with a media provider. In some implementations, to update the one or more media items, the logic when executed is further operable to cause the one or more processors to perform operations including replacing the one or more media items with new media items. In some implementations, to update the one or more media items, the logic when executed is further operable to cause the one or more processors to perform operations including rearranging an order of the one or more media items.

In some embodiments, a non-transitory computer-readable storage medium with program instructions thereon is provided. When executed by one or more processors, the instructions are operable to cause the one or more processors to perform operations including displaying a plurality of media items on a television, where each media item of the plurality of media items is an available service offering that a user may select; determining a predetermined presentation policy for updating one or more media items of the plurality of media items; and updating the one or more media items based on the predetermined presentation policy.

With further regard to the computer-readable storage medium, in some implementations, one or more presentation policies involve at least a predetermined time schedule. In some implementations, one or more presentation policies involve at least a predetermined ordering. In some implementations, one or more presentation policies are based at least on a state of the television. In some implementations, one or more presentation policies are based at least on a contractual agreement with a media provider. In some implementations, to update the one or more media items, the instructions when executed are further operable to cause the one or more processors to perform operations including replacing the one or more media items with new media items. In some implementations, to update the one or more media items, the instructions when executed are further operable to cause the one or more processors to perform operations including rearranging an order of the one or more media items.

In some implementations, a method includes displaying a plurality of media items on a television, where each media item of the plurality of media items is an available service offering that a user may select; determining a predetermined presentation policy for updating one or more media items of the plurality of media items; and updating the one or more media items based on the predetermined presentation policy.

With further regard to the method, in some implementations, one or more presentation policies involve at least a predetermined time schedule. In some implementations, one or more presentation policies involve at least a predetermined ordering. In some implementations, one or more presentation policies are based at least on a state of the television. In some implementations, one or more presentation policies are based at least on a contractual agreement with a media provider. In some implementations, the method further includes replacing the one or more media items with new media items.

A further understanding of the nature and the advantages of particular implementations disclosed herein may be realized by reference of the remaining portions of the specification and the attached drawings.

### BRIEF DESCRIPTION OF THE DRAWINGS

FIG. 1 illustrates a block diagram of an example media environment, which may be used for some implementations described herein.

FIG. 2 is an example flow diagram for presenting service offerings on a consumer device, according to some implementations.

FIG. 3 is an example embedded user interface with a set of service selections, according to some implementations.

FIG. 4 is an example graph showing the infrastructure impact of updating the offers on demand such as hosting the device user interface (UI) as a web page on a server.

FIG. 5 is an example graph showing the infrastructure impact of having the primary interaction driven from the server to the client, according to some implementations.

FIG. 6 is an example flow diagram for pushing updates to clients, according to some implementations.

FIG. 7 is an example layout, where a number of slots are assigned to each offer, according to some implementations.

FIG. 8 is another example layout, where a number of slots are assigned to each offer, according to some implementations.

FIG. 9 is an example block diagram for providing optional buffer management, according to some implementations.

FIG. 10 is another example block diagram for providing optional buffer management, according to some implementations.

FIG. 11 is an example layout, where some slots are allocated based on an agreement between a manufacturer and a service provider, according to some implementations.

FIG. 12 is a block diagram of an example network environment, which may be used for some implementations described herein.

FIG. 13 is a block diagram of an example computer system, which may be used for some implementations described herein.

### DETAILED DESCRIPTION

Implementations described herein enable, facilitate, and manage a consumer device such as a television in presenting daily updated service offerings for available media items from which a user may select. Such offerings may include, for example, movie services, sports services, news services, help, extended warranties, game services, etc. As described in more detail herein, embodiments decouple the user device (e.g., television) display from the server while still showing new service offerings at a set interval (e.g., daily). The length of the interval may vary, and will depend on the particular implementation. Such decoupling of the user device and server greatly reduces infrastructure costs.

Embodiments described herein allow for changing a service, the service appearance, and/or order of the service offerings to be shown on a daily basis (or other predetermined timeframe) while keeping the supporting infrastructure costs to a minimum. For example, in some embodiments, the system may present a single service at a position in the user interface that shows a different item of content for that service each day. In other words, while the service offering remains the same, the appearance of the service (e.g., image, label, etc.) can change each day. In some embodiments, the system may enable different services to share the same position or may re-order services (subject to any contractual limitations in some cases). This maintains customer engagement with the TV and other media player products such as Blu-ray™ products. This also enhances the brand by giving people a better experience than the competition.

As described in more detail herein, in various embodiments, a system displays media items on a consumer device such as a television. In various embodiments, each media item is an available service offering that a user may select. The system determines a predetermined presentation policy for updating one or more of the media items. The system updates the one or more media items based on the predetermined presentation policy.

FIG. 1 illustrates a block diagram of an example media environment 100, which may be used for some implementations described herein. In some implementations, media environment 100 includes a television 102 and a service provider 104, which may communicate with each other via a network 106. In some implementations, the network may be the Internet. In some implementations, the network may include a combination of networks such as the Internet, a wide area network (WAN), a local area network (LAN), a Wi-Fi network, a Bluetooth network, near-field communication (NFC) network, cable network, etc.

In various implementations, a user may use a remote control 108 to communicate with a system 110 associated with television 102. In various implementations, system 110 may be integrated with television 102, and control television 102. In some alternative implementations, system 110 may also be separate from television 102, e.g., in a set-top box, and still control what gets displayed on the television 102.

In various implementations, metadata associated with media items and presentation policies may be stored in a configuration file (not shown) that is accessible by system 110. In this particular example implementation, the configuration file is stored at system 110. In some embodiments, the configuration file may be stored remotely from system 110 and accessible by system 110.

In various embodiments, service offerings may be provided by a service provider such as service provider 104, for example. System 110 may communicate with service provider 104 on behalf of television 102 in order to access such service offerings upon selection by a user. Various example implementations directed to the presentation of service offerings are described in detail herein.

Although implementations disclosed herein are described in the context of televisions, the implementations may also apply to other media player devices such as Blu-ray™ players, computers, tablets, smart phones etc.

FIG. 2 is an example flow diagram for presenting service offerings on a consumer device, according to some implementations. Referring to both FIGS. 1 and 2, a method is initiated at block 202, where a system such as system 110 displays media items on a television such as television 102. In various embodiments, each media item is an available service offering that a user may select. In various embodiments, the system displays the media items by displaying an image for each media item, where each image represents an available television or service offering. As described in more detail herein, the system may arrange the media items in a preconfigured configuration. For example, the preconfigured configuration may be rows, columns, an array, etc. Also, in various embodiments, the system enables the preconfigured configuration to be scrollable (e.g., horizontal direction, vertical direction, etc.). In various embodiments, the system, may arrange the media items into subject matter categories or groupings. For example, such categories may include sports, movies, etc.

FIG. 3 is an example embedded user interface 300 with a set of service selections, according to some implementations. Such service selections may be referred to as service offerings, television offerings, offerings, offers, or media items. These terms may be used interchangeably. Shown are offerings or offers (e.g., Offer 1, Offer 2, Offer 3, Offer 4). In various embodiments, these offers or media items may be arranged in scrollable rows with category titles such as movies, games, sports, news, shopping, etc. While four offers are shown, there may be any number of offers available for user selection. Arrow 302 is a scroll button that enables the user to view additional offers or media items not currently shown on the screen.

In various embodiments, offerings may be shown in a single row with or without groupings per subject matter. Scrollable rows of offers may be arranged horizontally or vertically. Offers may also be arranged as a large array, which is scrollable horizontally and/or vertically. Regardless of the arrangement, each offer is represented by an image of a media item, which is meant to entice the customer to use that service. Embodiments described herein make the selectable media items or offers look new and different on a regular basis.

In some embodiments, regarding embedded devices such as televisions, these offers are a dynamic set that gets updated regularly. In various embodiments, the offerings are pre-loaded so that there is little wait time for the user to see the set of selections. The image assets needed to construct the set of items to select are stored locally. As such, they will be shown to the user as quickly as possible.

Referring again to FIG. 2, at block 204, the system determines a predetermined presentation policy for updating one or more of the media items. The presentation policy may be controlled by a download from the server to indicate which items may be swapped around, when to show something different, etc. In various embodiments, one or more presentation policies may involve a predetermined time schedule, including predetermined time intervals. For example, the system may update offerings being displayed on a daily basis, a once a week basis, etc., on the client device. In some embodiments, updates for a particular offering may be staggered across the week. For example, the system may update a predetermined set of offerings more often on weekends or other high-viewing days. Further example embodiments directed to predetermined time schedules are described in more detail herein.

In various embodiments, one or more presentation policies may involve at least a predetermined ordering. For example, in some embodiments, the system may place more recent offerings in more visible positions or slots on the user interface. For example, a more visible slot may be for the left-most slot in a row of selections, or the top-most slot in a column of selections, etc.

In various embodiments, one or more presentation policies are based at least on a contractual agreement with a media provider, where the system allows for fixed placement positions for some offers which have an agreed contract for it. For example, in various embodiments, the system may determine offer placement positions or slots in the user interface based on agreed contract. While some placement positions might not change, embodiments enable the image representing each of the services to change to represent different things such as their latest movie content, upcoming live streamed event, an offer for a free trial, etc. People respond more if the media item selections or offers are changed daily, which maintains or refreshes user attention and engagement.

In various embodiments, one or more presentation policies are based at least on a state of the television. For example, the system may update a device with new offers when the device is in standby mode. In another example, system may update a device with new offers when the user is viewing a video from non-internet source. In these scenarios, bandwidth is not being needed, which are optimal times for the system to perform updates. Further example embodiments directed to the state of the television are described in more detail herein.

At block 206, the system updates the one or more media items based on the predetermined presentation policy. As described in more detail herein, in various embodiments, the system updates one or more of the media items or offerings by replacing the one or more media items with new media items. In various embodiments, the system updates one or more of the media items including rearranging an order of the one or more media items. Further example embodiments directed to updating media items are described in more detail herein.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

FIG. 4 is an example graph 400 showing the infrastructure impact of updating the offers on demand such as hosting the device UI as a web page on a server. The example graph of FIG. 4 provides a comparison and contrast to a graph resulting from the various embodiments described herein. The graph resulting from the various embodiments is described below in connection to FIG. 5.

Referring to FIG. 4, during peak viewing hours, millions of televisions and media players (e.g., Blu-ray™ players), which have applications and services on them, are on and request updated material from the server. As shown, the number of server requests from clients is in the millions per hour (left, vertical axis). It is costly for the infrastructure to be able to handle the peak load, which in this case means providing these updates to millions of televisions at the same time.

Handling this load costs many tens of millions of dollars in infrastructure costs per year (right, vertical axis). There is a direct relationship between the number of requests from clients and the infrastructure costs, where the infrastructure cost to support a given level of request traffic increases as the number of requests from clients goes up. This high-capacity infrastructure may remain mostly idle outside of the peak viewing hours. Another drawback is that during the data fetch from the server, as much bandwidth as possible is used from the customers home network in order to provide a fast response for the user interface. This can impact others in the family who may be using that same home network. As shown, the three bars from left to right for each day of the week represent respective morning, afternoon, and evening time periods. In the chart, the left vertical axis shows request traffic and the right axis shows the infrastructure cost to support that level of request traffic.

In contrast to the scenario of FIG. 4, embodiments described herein provide a means to give customers a new selection on a daily basis while only updating the offers (e.g., once a week, etc.) as a low-demand background process. This keeps the media item selections new and interesting to customers while keeping the infrastructure costs to a minimum. Being able to update the imagery used for offers such as movie services means more user engagement. That increased user engagement in turn results in the perception of a higher quality product from users. This perception of higher quality translates to higher sales and higher sales margins.

FIG. 5 is an example graph 500 showing the infrastructure impact of having the primary interaction driven from the server to the client, according to some implementations. In various embodiments, the system spreads or distributes the server load over a long period of time in order to keep the infrastructure costs low. The device updates may occur while each device is in a standby mode and/or during times when the device needs on the Internet are low. For example, device needs and bandwidth may be low when the user is playing casual games, viewing video from a non-Internet source such as a cable box, playing a Blu-ray™ disk, etc. The background update enables a lower transfer rate while being able to update all the installed devices over time. This minimizes the impact of the update on the customers' home network.

As shown, the number of server actions to clients can be less than one million per hour (left, vertical axis), which is substantially lower than the number of server requests shown in FIG. 4. There is a direct relationship between the number of actions to clients and the infrastructure costs, where the infrastructure cost to support a given level of request traffic increases as the number of actions to clients goes up. As a result, the proportional infrastructure costs to support updates (right, vertical axis) are substantially lower than the costs associated with FIG. 4. As shown, the three bars from left to right for each day of the week represent respective morning, afternoon, and evening time periods. In an example scenario, if there are 10 million devices, it takes only a few minutes to update any device due to small image sizes. At 500,000 devices per hour, the system may update them all in less than one days' time (e.g., in 20 hours, etc.). Because the system updates a given client device when the device is in an appropriate state (e.g., in a stand by mode, or sleep mode, etc.), the system may spread the updates out over a week. This also means that the system has time to send larger updates such as software upgrades to the device. In some embodiments, the system may spread such larger updates out over more than one week, depending on the size of the update package and the number of devices to update. In most cases for these large system updates or upgrades, the population of devices will consist of several different models, and typically only one or two models will get updated at the same time.

As indicated herein, the device manufacturer includes these service offers as a selling point for their products but does not typically generate much of an income based on their use unless the manufacturer owns the movie service. The device manufacturer is in a position of needing to provide services and offers (e.g., movie on demand, sports, news, shopping, etc.) while not gaining much in the way of income to cover the infrastructure costs needed to support offering those services. Thus, the infrastructure costs for the data center needed must be minimized. Embodiments described herein facilitate in achieving such low infrastructure costs.

In various embodiments, funding from service offerings on a consumer device may be gained based on a placement fee from top tier movie services to ensure their service offer is prominently displayed. This can be a monthly, quarterly or yearly fee agreed upon in a contract to have a specific placement position on the device user interface. There may also be in some cases a small fee paid when a user registers for a movie service monthly subscription through the TV or Blu-ray™ player. There may also be a tiny click-through fee associated with how many users access the service through the device. These fees, however, are not sufficient to provide any substantial budget to pay for the infrastructure needed for all of the individual devices. In some cases, the manufacturer must cover the difference. Embodiments described herein maintain a minimal infrastructure while having the set of offers get updated on a regular basis. This increases user engagement and the number of people accessing services.

Another advantage of the embodiments described herein is that the daily update provides advertising from companies that provide such things as extended service plans, bonus offers, time limited deals, etc. from the service providers to entice people to sign up. By charging a fee for this advertising capability, additional revenue may be generated for the manufacturer.

FIG. 6 is an example flow diagram for pushing updates to clients, according to some implementations. Referring to both FIGS. 1 and 6, a method is initiated at block 602, where a system such as system 110 determines each known device and each device in the waitlist. The following steps are performed on each device.

At block 604, the system determines if the power is on. If yes, at block 606, the system adds the device to the waitlist if not already listed in the waitlist. In various embodiments, the system postpones any updates on a given device if that device is in use by adding the device to the waitlist. This enables the user to continue using the device without any interruptions or slow-downs in services. In some alternative implementations, the system may update a given device as a trickle feed while the device is being used. The system may first ensure that such trickle feeds do not result in streaming video being buffered if the customer does not have enough bandwidth from their Internet service provider (ISP).

At block 608, if the device is not powered on, the system determines if the device is in standby mode. At block 610, if the device is not in standby mode, the system puts the device in standby mode. By checking if each device is in standby mode before updating, the system avoids impacting the customer's video viewing experience. If a device is on and streaming video every day for twenty-four hours, it is most likely a display model in a store somewhere. There are several modes in these devices such a boot up from power off, the on state, a standby state, and a very low-power consumption standby state. In some embodiments, when a device is powered on, the device requests data from the server if the device does not already have the data it needs. An example would be when the device is brought home and set up.

At block 612, the system updates the device based on one or more presentation policies described herein. At block 614, the system places device in low-power mode. In some embodiments, when the customer presses the off button, the device will move to standby mode for a period of time and then move to a very low-power mode. This very low-power state does allow the device to monitor for remote input and server prompts over the Internet. Upon receiving a prompt from the server, the device moves back to standby mode where it takes a server update, which can include new offer images, software updates, other system updates, etc. Once the updates are complete, the device will go back to low-power standby.

At block 616, the system removes the device from waitlist. The order in which the server contacts devices may be predicated on the device location ascertained through its IP address. In some implementations, if it is after midnight in the device's time zone, the device goes to the top of the processing order. There are many strategies possible.

Providing updates based on a time schedule and/or predetermined time intervals enables a predetermined set of selections to get updated at regularly (e.g., daily intervals) while only needing to have the information for the offers updated on a weekly basis. From the customer viewpoint, the offers are changing every day. From the operator's standpoint, they get updated on an extended regular basis such as weekly. This decouples the user interface on the device from update requests to the server, which in turn greatly reduces infrastructure costs. Example embodiments directed to update time schedules are described in more detail herein, in connection with FIGS. 7 and 8, for example.

FIG. 7 is an example layout 700, where a number of slots are assigned to each offer, according to some implementations. Shown are offers (e.g., Offer 1, Offer 2, Offer 3, Offer 4, Offer 5, and Offer 6) arranged in a row. While six offers are shown, there may be more than six offers available for user selection. For example, as indicated herein, the offers may be scrollable in order to present more offers for user selection.

In various embodiments, a different set of slots is used for the offers each day, where there is more than one slot in a column filled for a given offer. In this particular example embodiment, each offer has four slots assigned. For example, each column may be allocated to one offer. In this example embodiment, the four slots for a given offer are in the same column, where each slot has a different image for the same offer.

FIG. 8 is an example layout 800, where a number of slots are assigned to each offer, according to some implementations. In the example embodiment shown, there are four slots per category item. On day 1 (e.g., Thursday), the image in the top-most slot for each item is shown. On day 2 (e.g., Friday), the image in the second-from-the-top-most slot for each item is shown. On day 3 (e.g., Saturday), the image in the-third-from-the-top-most slot for each item is shown. On day 4 (e.g., Sunday), the image in the bottom-most slot for each item is shown. The particular days may vary, depending on the particular implementation. For example, in this example embodiment, the days mentioned (e.g., Thursday, Friday, Saturday, and Sunday are high-viewing days.

In the example embodiment shown, on day 5 (e.g., Monday), the odd number items go back to being shown in the top-most slot, and the even number items go to being shown in the second-from-the-top-most slot. On day 6 (e.g., Tuesday), the odd number items go back to being shown in the second-from-the-top-most slot, and the even number items go to being shown in the third-from-the-top-most slot. On day 7 (e.g., Wednesday), the odd number items go back to being shown in the third-from-the-top-most slot, and the even number items go to being shown in the bottom-most slot. The particular days may vary, depending on the particular implementation. For example, in this example embodiment, the days mentioned (e.g., Monday, Tuesday, and Wednesday are lower-viewing days.

The resulting set of selections will not duplicate what was shown on day 1. If the system sets day 1 as Thursdays, then Thursday through Sunday will have a unique selection of items to choose from. Monday, Tuesday and Wednesday will have varied combinations of the first four days.

There may be a case where only one media item is assigned to one slot for an offer. In that case, the media item may be static until other slots for that offer are filled in. The number of slots per offer position is implementation dependent. For this example, there are four slots per position to provide seven days' worth of visual changes, while keeping the infrastructure burden down to a minimum level for the weekly update.

The memory needs in this scenario are similar to a static case in that in many cases for the old method the image assets are stored on the device. For example, in some embodiments, the image assets may be stored as portable network graphics (PNG) format files, which have little or no compression. Other formats are possible. For example, by changing over to joint pictures expert group (JPEG) format, the compression gains allow the four images to fit in nearly the same memory size. Instead of “on demand,” the updates are done once a week so by spreading the updates out evenly over time. As a result, the infrastructure costs are minimized. Also, because the images are stored on the device, the images are displayed to the customer as quickly as possible.

FIG. 9 is an example block diagram 900 for providing optional buffer management, according to some implementations. Shown on the left are a server 902, client interface 904, buffer cache A 906, buffer cache B 908, and non-volatile memory (NVM) manager 910. Shown on the right are a server 912, client interface 914, buffer cache A 916, buffer cache B 918, and NVM manager 920.

In various embodiments, the system toggles back and forth between the two sides. On each side, the respective cache A and cache B alternate between their duties. For example, referring to the left side, when a first download is complete, the images for the first set of offers in cache A 906 are written to NVM through the NVM manager 910. At the same time, the images for the second offer are downloaded to cache B 908. When both updates are complete, the data in cache B 908 is written to NVM through the NVM manager 910 while cache A 906 receives new data. This process continues until all of the images for all offers have been updated. The NVM manager may pool the data internally and write large compacted blocks of data to the actual non-volatile memory.

In some embodiments, if the television is turned on during the update, the process is paused until the television (or Blu-ray™ player) is turned off again. When the process completes, the memory for the cache may or may not be freed up depending on the implementation. The time needed to copy from the cache to replace the old images is very fast and has no significant impact on the time needed to download the data from the server.

In some embodiments, the system may optionally use three or more caches, where one or more caches are receiving the download while the remaining cache is updating the images for an offer. For example, the system may toggle back and forth between caches on the left and the caches on the right. As a cache completes downloading from the server, its data is written to the NVM of the respective NVM manager.

FIG. 10 is another example block diagram 1000 for providing optional buffer management, according to some implementations. Shown is a memory space 1002. In various embodiments, memory area 1002 serves two functions. When the device is on, memory area 1002 is used to buffer the incoming video stream for smooth delivery to the video decoder.

When the device is in standby mode, memory area 1002 is used to buffer updates to the device. This method decreases the memory needs of the device by sharing the buffer between video streaming and updating the device. During device update, the buffer may be partitioned into two or more areas. The partitioning of memory area 1002 and/or other memory areas may depend on several factors. Such factors may include a need for a software update to the device, only needing to update the offer images, whether several memory areas will be used to update the offers, etc.

FIG. 11 is an example layout 1100, where some slots are allocated based on an agreement between a manufacturer and a service provider, according to some implementations. Shown are a first set of offers 1102 and a second set of offers 1104.

The first set of offers 1102 have placement agreements, and their positions do not change. The offer images shown for each position do change based on one or more presentation policies described herein. Any number of the offers may have placement agreements.

The second set offers 1104 do not have placement agreements. The system may change or shuffle their positions on based on one or more presentation policies described herein. This heightens the perception of a dynamic selection of items. It also supports the impression that updated selections are being provided. The shuffle method may vary, depending on the particular implementation. For example, the shuffle method may be based on a combination of any of the following: rotating the items, reversing the order, shifting according to groups (e.g., as sports, games, news, etc.), most recently viewed or other methods, etc. The shuffle may happen daily, hourly, and/or whenever the user interface is brought up to view.

Embodiments described herein provide various benefits. For example, embodiments facilitate active updating of service offerings while minimizing associated infrastructure costs. Embodiments also minimize compromises in quality of service during updates to service offerings.

FIG. 12 is a block diagram of an example network environment 1200, which may be used for implementations described herein. In some implementations, network environment 1200 includes a system 1202, which includes a server device 1204 and a database 1206. Network environment 1200 also includes client devices 1210, 1220, 1230, and 1240, which may communicate with system 1202 and/or may communicate with each other directly or via system 1202. Network environment 1200 also includes a network 1250 through which system 1202 and client devices 1210, 1220, 1230, and 1240 communicate. Network 1250 may be any suitable communication network such as a Wi-Fi network, Bluetooth network, the Internet, etc.

In various implementations, system 1202 may be used to implement embodiments described herein in combination with or in lieu of system 110 of FIG. 1. Also, client devices 1210, 1220, 1230, and 1240 may be used to implement embodiments described herein.

For ease of illustration, FIG. 12 shows one block for each of system 1202, server device 1204, and network database 1206, and shows four blocks for client devices 1210, 1220, 1230, and 1240. Blocks 1202, 1204, and 1206 may represent multiple systems, server devices, and databases. Also, there may be any number of client devices. In other implementations, network environment 1200 may not have all of the components shown and/or may have other elements including other types of elements instead of, or in addition to, those shown herein.

While server 1204 of system 1202 performs embodiments described herein, in other embodiments, any suitable component or combination of components associated with server 1202 or any suitable processor or processors associated with server 1202 may facilitate performing the embodiments described herein.

Implementations may apply to any network system and/or may apply locally for an individual user. For example, implementations described herein may be implemented by system 1202 and/or any client device 1210, 1220, 1230, and 1240. System 1202 may perform the implementations described herein on a stand-alone computer, tablet computer, smartphone, etc. System 1202 and/or any of client devices 1210, 1220, 1230, and 1240 may perform implementations described herein individually or in combination with other devices.

In the various implementations described herein, a processor of system 1202 and/or a processor of any client device 1210, 1220, 1230, and 1240 causes the elements described herein (e.g., information, etc.) to be displayed in a user interface on one or more display screens.

FIG. 13 is a block diagram of an example computer system 1300, which may be used for some implementations described herein. For example, computer system 1300 may be used to implement server device 110 of FIG. 1, as well as to perform implementations described herein. In some implementations, computer system 1300 may include a processor 1302, an operating system 1304, a memory 1306, and an input/output (I/O) interface 1308. In various implementations, processor 1302 may be used to implement various functions and features described herein, as well as to perform the method implementations described herein. While processor 1302 is described as performing implementations described herein, any suitable component or combination of components of computer system 1300 or any suitable processor or processors associated with computer system 1300 or any suitable system may perform the steps described. Implementations described herein may be carried out on a user device, on a server, or a combination of both.

Computer system 1300 also includes a software application 1310, which may be stored on memory 1306 or on any other suitable storage location or computer-readable medium. Software application 1310 provides instructions that enable processor 1302 to perform the implementations described herein and other functions. Software application may also include an engine such as a network engine for performing various functions associated with one or more networks and network communications. The components of computer system 1300 may be implemented by one or more processors or any combination of hardware devices, as well as any combination of hardware, software, firmware, etc.

For ease of illustration, FIG. 13 shows one block for each of processor 1302, operating system 1304, memory 1306, I/O interface 1308, and software application 1310. These blocks 1302, 1304, 1306, 1308, and 1310 may represent multiple processors, operating systems, memories, I/O interfaces, and software applications. In various implementations, computer system 1300 may not have all of the components shown and/or may have other elements including other types of components instead of, or in addition to, those shown herein.

Although the description has been described with respect to particular embodiments thereof, these particular embodiments are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A system comprising:
one or more processors; and
logic encoded in one or more non-transitory computer-readable storage media for execution by the one or more processors and when executed operable to cause the one or more processors to perform operations comprising:
displaying a plurality of media items on a television, wherein each media item of the plurality of media items is an available service offering that a user may select;
determining one or more presentation policies for updating one or more media items of the plurality of media items; and
updating the one or more media items based on the one or more presentation policies, wherein at least one presentation policy of the one or more presentation policies involve staggering updates for one or more media items of the plurality of media items across a week.

2. The system of claim 1, wherein at least one presentation policy of the one or more presentation policies involve at least a predetermined time schedule.

3. The system of claim 1, wherein at least one presentation policy of the one or more presentation policies involve at least a predetermined ordering.

4. The system of claim 1, wherein at least one presentation policy of the one or more presentation policies are based at least on a state of the television.

5. The system of claim 1, wherein at least one presentation policy of the one or more presentation policies are based at least on a contractual agreement with a media provider.

6. The system of claim 1, wherein, to update the one or more media items, the logic when executed is further operable to cause the one or more processors to perform operations comprising replacing the one or more media items with new media items.

7. The system of claim 1, wherein, to update the one or more media items, the logic when executed is further operable to cause the one or more processors to perform operations comprising rearranging an order of the one or more media items.

8. A non-transitory computer-readable storage medium with program instructions stored thereon, the program instructions when executed by one or more processors are operable to cause the one or more processors to perform operations comprising:
displaying a plurality of media items on a television, wherein each media item of the plurality of media items is an available service offering that a user may select;
determining one or more presentation policies for updating one or more media items of the plurality of media items; and
updating the one or more media items based on the one or more presentation policies, wherein at least one presentation policy of the one or more presentation policies involve staggering updates for one or more media items of the plurality of media items across a week.

9. The computer-readable storage medium of claim 8, wherein at least one presentation policy of the one or more presentation policies involve at least a predetermined time schedule.

10. The computer-readable storage medium of claim 8, wherein at least one presentation policy of the one or more presentation policies involve at least a predetermined ordering.

11. The computer-readable storage medium of claim 8, wherein at least one presentation policy of the one or more presentation policies are based at least on a state of the television.

12. The computer-readable storage medium of claim 8, wherein at least one presentation policy of the one or more presentation policies are based at least on a contractual agreement with a media provider.

13. The computer-readable storage medium of claim 8, wherein, to update the one or more media items, the instructions when executed are further operable to cause the one or more processors to perform operations comprising replacing the one or more media items with new media items.

14. The computer-readable storage medium of claim 8, wherein, to update the one or more media items, the instructions when executed are further operable to cause the one or more processors to perform operations comprising rearranging an order of the one or more media items.

15. A computer-implemented method comprising:
displaying a plurality of media items on a television, wherein each media item of the plurality of media items is an available service offering that a user may select;
determining one or more presentation policies for updating one or more media items of the plurality of media items; and
updating the one or more media items based on the one or more presentation policies, wherein at least one presentation policy of the one or more presentation policies involve staggering updates for one or more media items of the plurality of media items across a week.

16. The method of claim 15, wherein at least one presentation policy of the one or more presentation policies involve at least a predetermined time schedule.

17. The method of claim 15, wherein at least one presentation policy of the one or more presentation policies involve at least a predetermined ordering.

18. The method of claim 15, wherein at least one presentation policy of the one or more presentation policies are based at least on a state of the television.

19. The method of claim 15, wherein at least one presentation policy of the one or more presentation policies are based at least on a contractual agreement with a media provider.

20. The method of claim 15, further comprising replacing the one or more media items with new media items.
